(19) United States
(12) Patent Application Publication
(10) Pub. No.: US 2025/0186885 A1
(43) Pub. Date: Jun. 12, 2025

(54) METHOD FOR TRANSMITTING INFORMATION AND ELECTRONIC DEVICE THEREOF

(71) Applicant: NETEASE (HANGZHOU) NETWORK CO., LTD., Hangzhou, Zhejiang (CN)

(72) Inventor: Zidong HUANG, Guangzhou, Guangdong (CN)

(73) Assignee: NETEASE (HANGZHOU) NETWORK CO., LTD., Hangzhou, Zhejiang (CN)

(21) Appl. No.: 18/840,931

(22) PCT Filed: Feb. 22, 2023
(86) PCT No.: PCT/CN2023/077690

§ 371 Date: Aug. 23, 2024

(30) Foreign Application Priority Data
Feb. 23, 2022 (CN) 202210170362.X
Mar. 18, 2022 (CN) 202210270719.1

(51) Int. Cl. A63F 13/53; A63F 13/42

(52) U.S. Cl. CPC A63F 13/53; A63F 13/42

(57) ABSTRACT

A method for transmitting information and an electronic device are provided. The method includes: displaying an information transmission control at an initial position on a game interaction interface; in response to a first touch operation on the information transmission control, acquiring a movement state of a touch point corresponding to the first touch operation; in response to the movement state meeting a preset condition, determining a time during which the touch point corresponding to the first touch operation stays on the interface element when the touch point ends at the interface element; if the time is less than a first preset time, displaying the information transmission control at a target position on the game interaction interface, if the time is greater than or equal to the first preset time, acquiring prompt information corresponding to the interface element and transmitting the prompt information to a teammate.

### CROSS-REFERENCE TO RELATED APPLICATIONS

The present disclosure is a U.S. National Phase Application of International Application No. PCT/CN2023/077690, filed on Feb. 22, 2023, which is based on and claims the priority of China Patent Application No. 202210270719.1 filed on Mar. 18, 2022, entitled “INFORMATION TRANSFER METHOD AND APPARATUS, ELECTRONIC DEVICE, AND READABLE MEDIUM”, and the priority of China Patent Application No. 202210170362. X filed on Feb. 23, 2022, entitled “INFORMATION TRANSFER METHOD AND APPARATUS, ELECTRONIC DEVICE, AND READABLE MEDIUM”, the contents of which are incorporated by reference in the present disclosure for all purposes.

### TECHNICAL FIELD

The present disclosure relates to a technical field of games, in particular to a method for transmitting information, an apparatus for transmitting information, an electronic device and a non-transitory computer-readable medium.

### BACKGROUND

For team games, such as multiplayer online battle arena (MOBA) games, players are usually divided into two teams, and the two teams compete with each other in the scattered game map. During the game, players need to transmit information to each other to improve their chances of winning.

### SUMMARY

The present disclosure provides a method for transmitting information, where a game interaction interface is displayed through an electronic device, and an information transmission control and an interface element are displayed on the game interaction interface, including:
displaying the information transmission control at an initial position on the game interaction interface;
in response to a first touch operation on the information transmission control, acquiring a movement state of a touch point corresponding to the first touch operation;
in response to the movement state meeting a preset condition, determining a time during which the touch point corresponding to the first touch operation stays on the interface element when the touch point ends at the interface element;
if the time is less than a first preset time, displaying the information transmission control at a target position on the game interaction interface, where the initial position and the target position are respectively located in a left region and a right region of the game interaction interface; and if the time is greater than or equal to the first preset time, acquiring prompt information corresponding to the interface element and transmitting the prompt information to a teammate.

An embodiment of the present disclosure further discloses another method for transmitting information, where a game interaction interface is displayed through an electronic device, and an information transmission control and an interface element are displayed on the game interaction interface, including:
displaying the information transmission control at an initial position on the game interaction interface;
displaying the information transmission control at a target position on the game interaction interface in response to a third touch operation on the information transmission control, where the initial position and the target position are respectively located in a left region and a right region of the game interaction interface.

An embodiment of the present disclosure further discloses an electronic device, including a processor, a communication interface, a memory and a communication bus, where the processor, the communication interface and the memory communicate with each other through the communication bus:
the memory is configured to store a computer program; and the processor is configured to implement the method according to the embodiment of the present disclosure when executing the program stored in the memory.

### BRIEF DESCRIPTION OF THE DRAWINGS

FIG. 1 is a schematic diagram of an interface of operations of an information transmission control provided in the related art;

FIG. 2 is a flowchart of steps of a method for transmitting information provided in an embodiment of the present disclosure:

FIG. 3 is a first schematic diagram of an interface of the operation of an information transmission control provided in an embodiment of the present disclosure:

FIG. 4 is a second schematic diagram of an interface of the operation of an information transmission control provided in an embodiment of the present disclosure:

FIG. 5 is a flowchart of steps of another method for transmitting information provided in an embodiment of the present disclosure;

FIG. 6 is a third schematic diagram of an interface of the operation of an information transmission control provided in an embodiment of the present disclosure:

FIG. 7 is a fourth schematic diagram of an interface of the operation of an information transmission control provided in an embodiment of the present disclosure:

FIG. 8 is a fifth schematic diagram of an interface of the operation of an information transmission control provided in an embodiment of the present disclosure:

FIG. 9 is a structural block diagram of an apparatus for transmitting information provided in an embodiment of the present disclosure.

### DETAILED DESCRIPTION

In order to make the above objects, features and advantages of the present disclosure clearer and easier to understand, the present disclosure will be further described in detail with the accompanying drawings and specific embodiments.

At present, in the related art, prompt information corresponding to an interface element is transmitted to a teammate by directly dragging an information transmission control to the interface element in a game interface, for example, dragging the information transmission control to the blue buff triggers a message “I will take the blue (buff), thank you” and transmits the message to the teammate, in order to avoid a problem of untimely information transmission in the game process which is caused by inputting information to send or selecting information from many information to send.

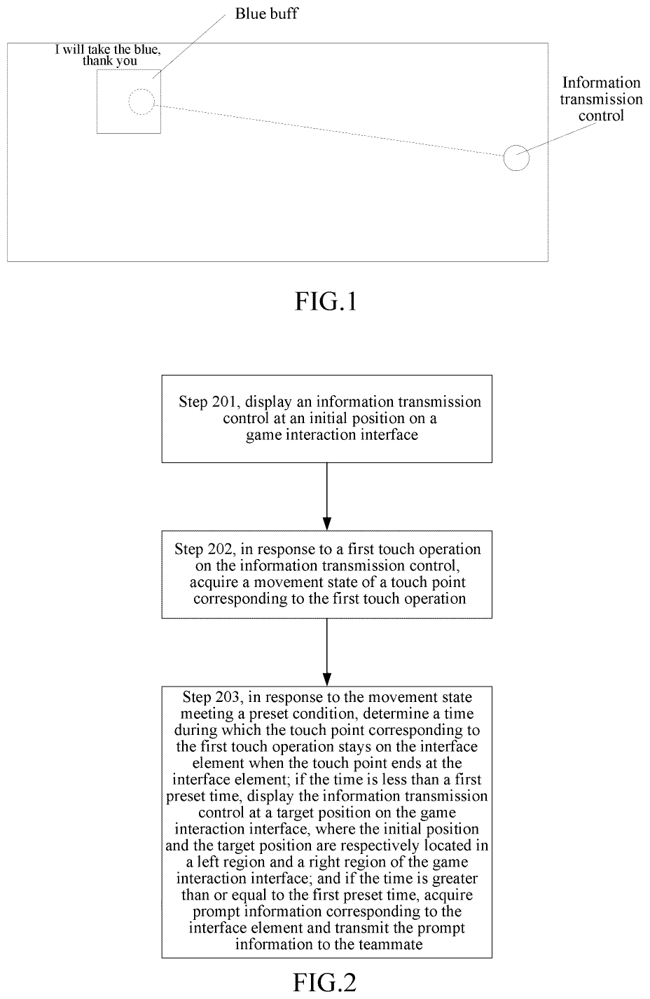

However, with the popularity of full-screen mobile phones, a screen size of the mobile phone is getting larger and larger. When the interface element and the information transmission control are located in regions on different sides of the game interface, for example, with reference to FIG. 1, when the information transmission control is located in a right region and the interface element (a blue buff) is located in a left region, a distance between the information transmission control and the interface element is too far, so it is difficult to drag the information transmission control to the interface element through a finger of a left hand, and the operation violates the human-machine size, resulting in untimely information transmission and affecting the player's game experience.

A method for transmitting information in an embodiment of the present disclosure may be run on a local terminal device or a server. When the method for transmitting information runs on the server, the method for transmitting information may be implemented and executed based on a cloud interactive system, where the cloud interactive system includes the server and a client device.

In an embodiment, various cloud applications, such as a cloud game, may be run under the cloud interactive system. Taking the cloud game as an example, the cloud game refers to a game based on cloud computing. In the running mode of the cloud game, the running subject of a game program and the presenting subject of a game screen are separated, and the storage and running of the method for transmitting information are completed on a cloud game server. The client device is used for receiving and sending data and presenting the game screen. For example, the client device may be a display device with a data transmission function near a user side, such as a first terminal device, a television, a computer, a PDA, etc. However, the method for transmitting information is performed by the cloud game server in the cloud. When playing a game, a player operates the client device to send an operation instruction to the cloud game server, and the cloud game server runs the game according to the operation instruction, encodes and compresses data such as the game screen, and returns the data to the client device through a network, and finally decodes and outputs the game screen through the client device.

In an embodiment, taking a game as an example, the local terminal device stores a game program and is used to present a game screen. The local terminal device is used to interact with a player through a graphical user interface, that is, to download and install the game program and run it through an electronic device. The local terminal device may provide the graphical user interface to the player in various ways, for example, the graphical user interface may be rendered and displayed on a display screen of the terminal, or the graphical user interface may be provided to the player through holographic projection. For example, the local terminal device may include a display screen for presenting the graphical user interface including a game screen and a processor for running the game, generating the graphical user interface and controlling the display of the graphical user interface on the display screen.

Referring to FIG. 2, a flowchart of steps of a method for transmitting information provided in an embodiment of the present disclosure is shown. A game interaction interface is displayed through an electronic device, and an information transmission control and an interface element are displayed on the game interaction interface, which may specifically include the following steps S201-S203.

In step 201: displaying the information transmission control at an initial position on the game interaction interface.

An information transmission control and several interface elements are displayed on the game interface. The information transmission control is used for the player to send information to his/her teammates or enemy teammates. There are three modes to send information. A first mode is to click the information transmission control and then input the text to be sent through a virtual keyboard. A second mode is that after clicking the information transmission control, some commonly used quick information is displayed, such as being careful of the grass, launching an attack, defending the highland, requesting support, etc., and one of them is selected for sending. A third mode is to drag the information transmission control directly to the interface element, and prompt information corresponding to the interface element may be previewed (displayed) in the game interaction interface, and the prompt information corresponding to the interface element is sent to the teammate after releasing the information transmission control. For example, when the interface element is a blue buff, when dragging the information transmission control to connect to the blue buff, the prompt information of “I'll take the blue (buff), thank you” may be previewed (displayed) in the game interaction interface, and after releasing the information transmission control, the prompt information of “I'll take the blue (buff), thank you” is sent to the teammate. The embodiment of the present disclosure is an optimization of the third information transmission mode.

The interface element at least includes a player virtual character, a non-player virtual character, a control, a virtual object, etc. The initial position of the information transmission control may usually be set in a game interface layout in a game setting before starting the game, usually on a left side or a right side of the game interface.

Specifically: after the game is started, the information transmission control is displayed at the initial position on the game interaction interface.

In step 202: in response to a first touch operation on the information transmission control, acquiring a movement state of a touch point corresponding to the first touch operation.

The first touch operation may be a sliding operation, a dragging operation or a pulling operation, etc. The touch point is a point that contacts with the game interaction interface during the first touch operation, and the movement state of the touch point corresponding to the first touch operation may be determined by at least one of the following parameters: a moving distance, a moving speed, a moving direction and a duration of the touch point.

In step 203: in response to the movement state meeting a preset condition, determining a time during which the touch point corresponding to the first touch operation stays on the interface element when the touch point ends at the interface element: if the time is less than a first preset time, displaying the information transmission control at a target position on the game interaction interface, where the initial position and the target position are respectively located in a left region and a right region of the game interaction interface; and if the time is greater than or equal to the first preset time, acquiring prompt information corresponding to the interface element and transmitting the prompt information to the teammate.

The target position is a preset transit display position of the information transmission control, and the initial position and the target position are respectively located in the left region and the right region of the game interaction interface. For example, the initial position is located in the left region and the target position is located in the right region, or the target position is located in the left region and the initial position is located in the right region. When the interface element and the target position are located in a region on the same side, a distance between the interface element and the initial position is greater than the distance between the interface element and the target position, and that is, the distance between the interface element and the initial position is relatively far, so it is difficult for the player to operate between the information transmission control and the interface element.

Specifically: when the interface element is away from the initial position, but close to the target position, the movement state of the touch point corresponding to the first touch operation may be acquired in response to the player's first touch operation on the information transmission control, and whether the movement state meets the preset condition may be determined. When the movement state meets the preset condition, and it is determined that when the touch point corresponding to the first touch operation ends at the interface element, the time during which the touch point stays on the interface element is less than the first preset time, the information transmission control is displayed at the target position. On the contrary, if the time during which the touch point corresponding to the first touch operation stays on the interface element when the touch point ends at the interface element is greater than the first preset time, the prompt information corresponding to the interface element is acquired, and the prompt information is transmitted to the teammate.

The first touch operation may be a sliding operation, a dragging operation or a pulling operation, etc. The interface element at least includes a player virtual character, a non-player virtual character, a control, a virtual object, etc. The prompt information corresponding to the interface element is different based on different interface elements. For example, the interface element is a virtual character controlled by the teammate player, and the corresponding prompt information is “here with me”. The interface element is a virtual character controlled by a friendly player, and the corresponding prompt information is “protect our teammates”. When the interface element is a skill control, the corresponding prompt information is “ultimate skill not upgraded” and “skill not cooled”. The interface element is grass, and the corresponding prompt information is “gather and ambush” and “beware of grass”. The interface element is a current monster (for example, a blue buff or a red buff) or boss, and the corresponding prompt information is “I will take the blue, thank you”. “I will take the red, thank you”. “attack the Pharaoh” and “attack the master”. The interface element is the teammate's turret, and the corresponding prompt information is “request for support”. The interface element is an enemy's turret, and the corresponding prompt information is “impact the enemy's turret”. The interface element is the teammate player's inhibitor, and the corresponding prompt information is “defend the highland”. The interface element is an enemy's inhibitor, and the corresponding prompt information is “attack the enemy's base first”.

Specifically: assuming that the initial position of the information transmission control is located in the right region of the game interaction interface, if the touch point corresponding to the first touch operation ends at one of the interface elements (for example, the red buff) located in the right region of the game interaction interface, and the time during which the touch point corresponding to the first touch operation stays on the interface element is less than a first preset time (for example, less than 0.5 second), the information transmission control is provided at the target position located in the left region of the game interaction interface. If the touch point corresponding to the first touch operation ends at one of the interface elements (for example, the red buff) located in the right region of the game interaction interface, and the time during which the touch point corresponding to the first touch operation stays on the interface element is greater than or equal to the first preset time (for example, greater than or equal to 0.5 second), the prompt information “I will take the red, thank you” corresponding to the interface element is acquired, and the prompt information is transmitted to the teammate.

There are many ways to display the information transmission control at the target position. For example, an information transmission control with the same function is displayed at the target position while retaining the information transmission control at the initial location, or the information transmission control at the initial position is moved to the target position for display, which is not limited by the embodiments of the present disclosure.

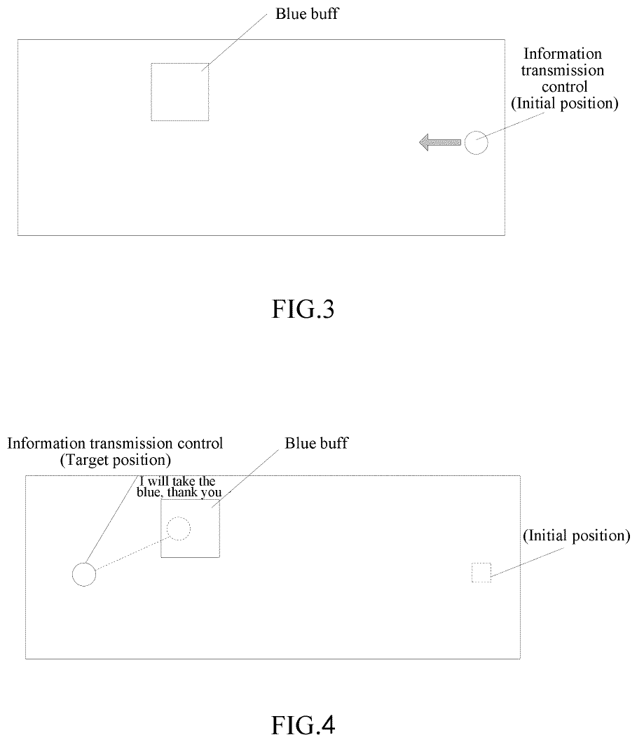

Referring to FIG. 3, a first schematic diagrams of an interface of the operation of an information transmission control provided in an embodiment of the present disclosure is shown. The information transmission control is located in the initial position in the right region of the game interaction interface, and the blue buff (the interface element) is located in the left region of the game interaction interface, and the interface element is away from the initial position. The information transmission control may be displayed at the target position in response to the player's first touch operation on the information transmission control (referring to FIG. 4, which shows a second schematic diagram of an interface of the operation of an information transmission control provided in an embodiment of the present disclosure), thus shortening the distance between the information transmission control and the interface element and facilitating the player's subsequent operation.

In the embodiment of the present disclosure, the information transmission control may be displayed at a target position close to the interface element in response to the first touch operation on the information transmission control at the initial position, thus shortening the distance between the information transmission control and the interface element, facilitating the information transmission operation of the player and optimizing the operation experience of the player playing the game with fingers on a full-screen game interface.

It should be noted that the time during which the touch point corresponding to the first touch operation stays on the interface element is used to distinguish an operation that triggers the display of the information transmission control at the target position and an operation that acquires the prompt information, in order to prevent the two operations from being triggered at the same time (displaying the information transmission control at the target position and acquiring the prompt information corresponding to the interface element), and avoid the user's misoperation. That is, by increasing the detection of an end position of the touch operation and the determination of the stay time, the composite functions in one-key multiplexing—triggering the change of the position of the control and triggering the transmission of the prompt information—may be effectively distinguished. For example, in response to the first touch operation on the information transmission control, there is another interface element near the initial position. If the movement state of the touch point corresponding to the first touch operation meets the preset condition and the touch point corresponding to the first touch operation moves to another interface element, which operation is triggered may be determined by the time during which the touch point corresponding to the first touch operation stays on another interface element. If the time during which the touch point corresponding to the first touch operation stays on another interface element is greater than or equal to a first preset time, the prompt information corresponding to another interface element is acquired. If the time during which the touch point corresponding to the first touch operation stays on another interface element is less than the first preset time, the information transmission control is displayed at the target position.

In an embodiment of the present disclosure, in response to a second touch operation on the information transmission control at the target position, if the touch point corresponding to the second touch operation moves from the target position to the interface element, and the time during which the touch point corresponding to the second touch operation stays on the interface element is greater than or equal to the first preset time, the prompt information corresponding to the interface element may be acquired, and the prompt information may be transmitted to the teammate.

The second touch operation may be a sliding operation, a dragging operation or a pulling operation, etc. The interface element at least includes a player virtual character, a non-player virtual character, a control, a virtual object, etc. The prompt information corresponding to the interface element is different based on different interface elements. For example, the interface element is a virtual character controlled by the teammate player, and the corresponding prompt information is “here with me”. The interface element is a virtual character controlled by a friendly player, and the corresponding prompt information is “protect our teammates”. When the interface element is a skill control, the corresponding prompt information is “ultimate skill not upgraded” and “skill not cooled”. The interface element is grass, and the corresponding prompt information is “gather and ambush” and “beware of grass”. The interface element is a current monster (for example, a blue buff or a red buff) or boss, and the corresponding prompt information is “I will take the blue, thank you”. “I will take the red, thank you”. “attack the Pharaoh” and “attack the master”. The interface element is a teammate's turret, and the corresponding prompt information is “request for support”. The interface element is an enemy's turret, and the corresponding prompt information is “impact the enemy's turret”. The interface element is the teammate's inhibitor, and the corresponding prompt information is “defend the highland”. The interface element is an enemy's inhibitor, and the corresponding prompt information is “attack the enemy's base first”. Specifically: after the information transmission control is displayed at the target position, in response to the player's second touch operation on the information transmission control at the target position, if the touch point corresponding to the second touch operation moves from the target position to the interface element, and the time during which the touch point corresponding to the second touch operation stays on the interface element is greater than or equal to the first preset time, the prompt information corresponding to the interface element is acquired and transmitted to the teammate.

Referring to FIG. 4, after the control information transmission control is displayed at the target position, in response to the second touch operation on the information transmission control located in the target position, the touch point corresponding to the second touch operation moves from the target position to the interface element and the time during which the touch point corresponding to the second touch operation stays on the interface element is greater than or equal to the first preset time, the prompt information “I will take the blue, thank you” corresponding to the blue buff is acquired, and the prompt information is transmitted to the teammate.

It should be noted that, in response to the first touch operation, the second touch operation or another touch operation on the information transmission control, the information transmission control may or may not follow the touch point corresponding to the touch operation, which may be set according to the actual needs. In the embodiment of the present disclosure, there is no limitation on whether the information transmission control follows the touch point corresponding to the touch operation.

In the embodiment of the present disclosure, when the interface element is away from the initial position but close to the target position, the information transmission control may be controlled to be displayed at the target position close to the interface element through the first touch operation initiated by a hand close to the initial position, thereby shortening the distance between the information transmission control and the interface element, and then the second touch operation on the information transmission control at the target position is initiated by a hand close to the target position, such that the touch point corresponding to the second touch operation moves to the interface element and the time during which the touch point stays on the interface element is greater than or equal to a second preset time, so as to quickly acquire the prompt information corresponding to the interface element and transmit the prompt information to the teammate. The prompt information corresponding to the interface element that is away from the information transmission control at the initial position may be quickly transmitted during the game, and the operation experience of the player playing the game with fingers on the full-screen game interface may be optimized, and the problem due to a long distance between the information transmission control and the interface element, which is difficult to drag the information transmission control to the interface element, and results in untimely information transmission and affecting the player's game experience, is solved.

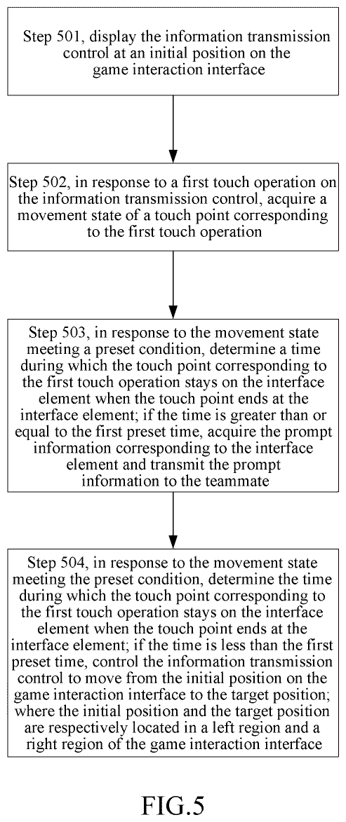

Referring to FIG. 5, a flowchart of steps of another method for transmitting information provided in an embodiment of the present disclosure is shown. A game interaction interface is displayed through an electronic device, and an information transmission control and an interface element are displayed on the game interaction interface, which may specifically include the following steps S501-S504.

In step 501: displaying the information transmission control at an initial position on the game interaction interface.

In step 502: in response to a first touch operation on the information transmission control, acquiring a movement state of a touch point corresponding to the first touch operation.

In an embodiment of the present disclosure, after the step 502, the method further includes step 503: in response to the movement state meeting a preset condition, determining a time during which the touch point corresponding to the first touch operation stays on the interface element when the touch point ends at the interface element: if the time is greater than or equal to the first preset time, acquiring the prompt information corresponding to the interface element and transmitting the prompt information to the teammate.

Specifically: when the interface element and the initial position are located in a region on the same side of the game interaction interface, that is, when the interface element is close to the initial position and away from the target position, the first touch operation that is performed by the player on the information transmission control at the initial position may be responded to directly, and when the touch point corresponding to the first touch operation moves from the initial position to the interface element and the time during which the touch point corresponding to the first touch operation stays on the interface element is greater than or equal to the first preset time, the prompt information corresponding to the interface element may be acquired and transmitted to the teammate.

It should be noted that in response to the player's first touch operation on the information transmission control at the initial position, when the touch point corresponding to the first touch operation moves from the initial position to the interface element and the time during which the touch point corresponding to the first touch operation stays on the interface element is greater than or equal to the first preset time, the information transmission control does not be displayed at the target position regardless of whether the movement state of the touch point corresponding to the first touch operation meets the preset condition, but the prompt information corresponding to the interface element is directly acquired and transmitted to the teammate.

Only when the time during which the touch point corresponding to the first touch operation stays on the interface element is less than the first preset time (including the case that the touch point corresponding to the first touch operation does not move to the interface element), and the movement state of the touch point corresponding to the first touch operation meets the preset condition, the information transmission control is displayed at the target position.

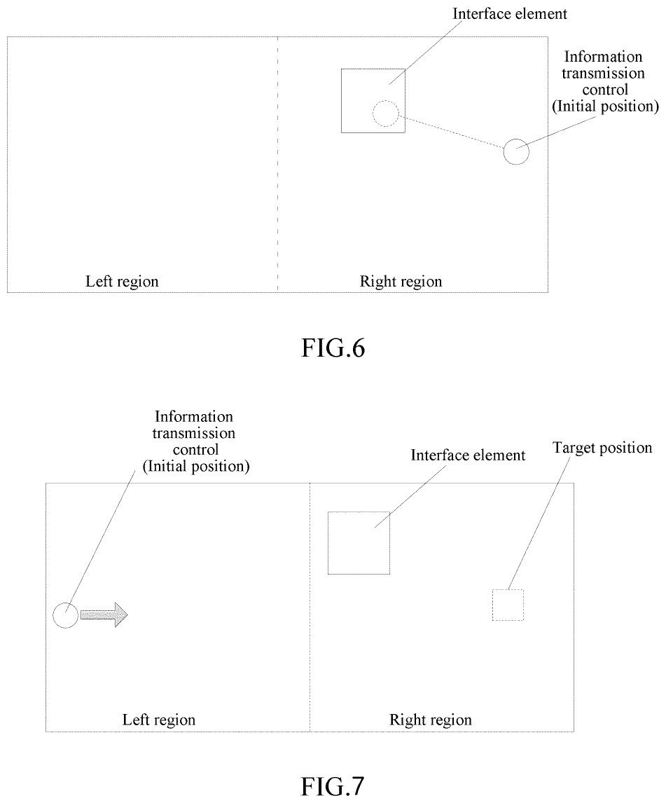

Referring to FIG. 6, a third schematic diagram of an interface of the operation of an information transmission control provided in an embodiment of the present disclosure is shown. Both the initial position of the information transmission control and the position of the interface element are located in a region on the right side of the game interaction interface, that is, the interface element is close to the information transmission control at the initial position, and the player's first touch operation on the information transmission control at the initial position may be responded to directly, and the touch point corresponding to the first touch operation moves from the initial position to the interface element and stays on the interface element for a period that is greater than or equal to the first time, the prompt information corresponding to the interface element may be acquired and transmitted to the teammate.

In the embodiment of the present disclosure, when the position of the interface element is close to the initial position, but is away from the target position, the problem that the information transmission control at the initial position is away from the interface element, which affects the transmission of prompt information, cannot occur. The prompt information corresponding to the interface element may be quickly acquired directly through the first touch operation on the information transmission control at the initial position, and the prompt information may be transmitted to the teammate, without displaying the information transmission control at the target position first and then acquiring the prompt information through the second touch operation on the information transmission control displayed at the target position.

In step 504: in response to the movement state meeting the preset condition, determining the time during which the touch point corresponding to the first touch operation stays on the interface element when the touch point ends at the interface element: if the time is less than the first preset time, controlling the information transmission control to move from the initial position on the game interaction interface to the target position: where the initial position and the target position are respectively located in a left region and a right region of the game interaction interface.

The initial position and the target position are respectively located in the left region and the right region of the game interaction interface.

Specifically: the information transmission control is moved from the initial position to the target position on the game interaction interface, which aims to quickly shorten the distance between the information transmission control and the interface elements, and the specific implementation may be realized in various ways, such as controlling the information transmission control to move quickly from the initial position to the target position on the game interaction interface, or controlling the information transmission control to jump from the initial position to the target position on the game interaction interface, or displaying the information transmission control at the target position while canceling displaying the information transmission control at the initial position. It may be set according to actual needs, and the embodiments of the present disclosure are not limited to this.

In an embodiment of the present disclosure, the preset condition includes: within a second preset time, a moving distance of the touch point corresponding to the first touch operation being greater than a preset distance, and a moving direction of the touch point corresponding to the first touch operation being within a preset direction range: or within the second preset time, a moving speed of the touch point corresponding to the first touch operation being greater than a preset speed, and the moving direction of the touch point corresponding to the first touch operation being within the preset direction range.

The movement state of the touch point corresponding to the first touch operation may meet various preset conditions. For example, when a moving distance of the touch point corresponding to the first touch operation is greater than a preset distance and a moving direction of the touch point corresponding to the first touch operation is within a preset direction range within a second preset time, the movement state of the touch point corresponding to the first touch operation meets the preset condition:
or, when a moving speed of the touch point corresponding to the first touch operation is greater than a preset speed and the moving direction of the touch point corresponding to the first touch operation is within the preset direction range within the second preset time, the movement state of the touch point corresponding to the first touch operation meets the preset condition;
or, when the moving distance of the touch point corresponding to the first touch operation is greater than the preset distance within the second preset time, the movement state of the touch point corresponding to the first touch operation meets the preset condition;
or, when the moving speed of the touch point corresponding to the first touch operation is greater than the preset speed within the second preset time, the movement state of the touch point corresponding to the first touch operation meets the preset condition.

The preset conditions may be set according to actual needs, which is not limited in the embodiments of the present disclosure. For example, the preset conditions may also be set according to a moving acceleration, a moving angle and a pressing force of the touch point corresponding to the first touch operation.

When the movement state of the touch point corresponding to the first touch operation meets the preset condition, and a stay time of the touch point corresponding to the first touch operation in the interface element is less than the first preset time, the information transmission control is displayed at the target position.

The preset direction range may also be set according to specific conditions. In an embodiment of the present disclosure, when the initial position of the information transmission control is located in the left region of the game interaction interface and the target position is located in the right region of the game interaction interface, the preset direction range is a direction toward the right; when the initial position of the information transmission control is located in the right region of the game interaction interface and the target position is located in the left region of the game interaction interface, the preset direction range is a direction toward the left.

When the initial position of the information transmission control is located in the left region of the game interaction interface, the target position is located in the right region of the game interaction interface. The preset direction range is the direction toward the right, with the initial position as an origin, and the direction values may be: the direction toward the right [−45°, 45°), an upward direction [−45°, 135°), and the direction toward the left [−135°, 135°), and a downward direction [−135°, −45°). The specific range of the direction may be set as required, such as the direction toward the right may also be [−40°, 40°), [−50°, 50°) or [−60°, 60°).

Referring to FIG. 7, a fourth schematic diagram of an interface of the operation of an information transmission control provided in an embodiment of the present disclosure is shown. The initial position of the information transmission control is located in the left region of the game interaction interface, and the positions of the target position and the interface element are located in the right region of the game interface. The preset direction range is the direction toward the right. Within the second preset time, the moving distance of the touch point corresponding to the first touch operation is greater than the preset distance or the moving speed of the touch point corresponding to the first touch operation is greater than the preset speed, and the moving direction of the touch point corresponding to the first touch operation is the direction toward the right, such that the movement state of the touch point corresponding to the first touch operation may meet the preset condition.

When the initial position of the information transmission control is located in the right region of the game interaction interface, the target position is located in the left region of the game interaction interface, and the preset direction range is the direction toward the left.

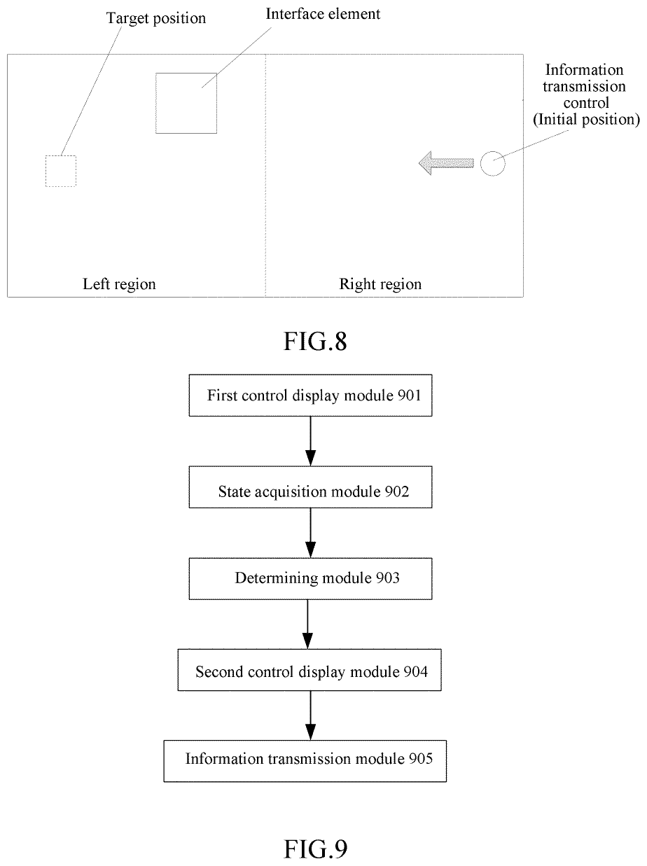

Referring to FIG. 8, a fifth schematic diagram of an interface of the operation of an information transmission control provided in an embodiment of the present disclosure is shown. The initial position of the information transmission control is located in the right region of the game interaction interface, and the positions of the target position and the interface element are located in the left region of the game interface. The preset direction range is the direction toward the left. Within the second preset time, the moving distance of the touch point corresponding to the first touch operation is greater than the preset distance or the moving speed of the touch point corresponding to the first touch operation is greater than the preset speed, and the moving direction of the touch point corresponding to the first touch operation is the direction toward the left, such that the movement state of the touch point corresponding to the first touch operation may meet the preset condition.

In the embodiment of the present disclosure, whether to display the information transmission control at the target position is determined by the moving distance and the moving direction of the touch point corresponding to the first touch operation on the game interaction interface, or is determined by the moving speed and the moving direction of the touch point corresponding to the first touch operation on the game interaction interface, and the time during which the touch point stays on the interface element within the second preset time, so as to avoid the user's misoperation and improve the user's operation fault tolerance.

In an embodiment of the present disclosure, after the step 203, the method further includes: in response to that a second touch operation on the information transmission control at the target position is not detected within a third preset time, cancelling displaying the information transmission control at the target position.

Specifically: after the information transmission control is displayed at the target position on the game interaction interface, if the second touch operation for the information transmission control is not detected within the third preset time, it indicates that the user does not need to perform information transmission operation on the information transmission control displayed at the target position, and the displaying of the information transmission control at the target position is cancelled.

In an embodiment of the present disclosure, in response to the second touch operation on the information transmission control, when the information transmission control is controlled to move from the target position to the position where the interface element is located, the prompt information corresponding to the interface element may be acquired and transmitted to the teammate.

In an embodiment of the present disclosure, after responding to the second touch operation on the information transmission control, the method further includes: if the time during which the touch point corresponding to the second touch operation stays on the interface element is less than the first preset time, canceling displaying the information transmission control at the target position.

Specifically: after responding to the second touch operation on the information transmission control, if the time during which the touch point corresponding to the second touch operation stays on the interface element is less than the first preset time (including the case that the touch point corresponding to the second touch operation does not move to the interface element), it indicates that the second touch operation is invalid, and the displaying of the information transmission control at the target position is cancelled.

In an embodiment of the present disclosure, the responding to the second touch operation on the information transmission control further includes: the determination for the stay time of the touch point for the second touch operation on the information transmission control located at the target position may not be performed, as long as the touch point ends at the interface element, no matter how long the stay time of the touch point is, the following functions are triggered: acquiring the prompt information corresponding to the interface element and transmitting the prompt information to the teammate.

In an embodiment of the present disclosure, the responding to the second touch operation on the information transmission control further includes: if the touch point of the second touch operation on the information transmission control located at the target position ends at another position of a non-interface element (the non-interface element is an element that is not the interface element), canceling displaying the information transmission control at the target position.

In an embodiment of the present disclosure, after acquiring the prompt information corresponding to the interface element, the method further includes: performing display and voice broadcast of the prompt information on the game interaction interface.

Specifically, after acquiring the prompt information corresponding to the interface element, the prompt information is previewed (displayed) in the game interface. After the player releases the touch operation on the information transmission control, the prompt information is displayed and broadcast by voice in the game interaction interface, and the prompt information is transmitted to the teammate.

In an embodiment of the present disclosure, after acquiring the prompt information corresponding to the interface element, the method further includes: canceling displaying the information transmission control at the target position.

Specifically, after the prompt information corresponding to the interface element is acquired and after the player releases the second touch operation on the information transmission control (after the second touch operation is completed), the transmission operation of the prompt information has completed, and the information transmission control at the target position is no longer needed. Thus, the displaying of the information transmission control at the target position is cancelled.

In an example of the present disclosure, the information transmission control may also be directly displayed at the target position of the interaction interface in response to one or any combination of a single-click touch operation, a double-click touch operation, a multi-touch operation, a long-press touch operation or another touch operation for the information transmission control.

In an example of the present disclosure, all interface elements with the prompt information in the interaction interface may be displayed differently from the interaction interface in response to touch operations such as the double-click operation, the long-press operation and the like or another touch operation on the information transmission control, and the prompt information corresponding to the interface element may be acquired in response to a click touch operation on a differently displayed interface element, and the prompt information may be sent to the teammate.

In the embodiment of the present disclosure, whether to display the information transmission control at the target position is determined by the moving distance and moving direction (or the moving speed and moving direction) of the touch point corresponding to the first touch operation within the second preset time, and the time during which the touch point stays on the interface element, such that the operation fault tolerance is higher, and the user's misoperation may be avoided.

When the position of the interface element is close to the initial position, but is away from the target position, the problem that the information transmission control at the initial position is away from the interface element, which affects the transmission of prompt information, cannot occur. Through the first touch operation on the information transmission control at the initial position, the prompt information corresponding to the interface element may be directly acquired and transmitted to the teammate, without displaying the information transmission control at the target position first and then acquiring the prompt information through the second touch operation of the information transmission control displayed at the target position.

When the position of the interface element is away from the initial position, but is close to the target position, the information transmission control may be controlled to be displayed at the target position close to the interface element through the first touch operation initiated by a hand close to the initial position, thus shortening the distance between the information transmission control and the interface element, and then the second touch operation on the information transmission control at the target position is initiated by a hand close to the target position, such that the prompt information corresponding to the interface element may be quickly acquired and transmitted to the teammate. Thus, the prompt information corresponding to the interface element that is away from the information transmission control at the initial position may be quickly transmitted in the game process, and the operation experience of the player playing the game with fingers on the full-screen game interface may be optimized, and the problem due to a long distance between the information transmission control and the interface element, which is difficult to drag the information transmission control to the interface element, and results in untimely information transmission and affecting the player's game experience, is solved.

In addition, the present disclosure further provides another embodiment of the method for transmitting information, where a game interaction interface is displayed through an electronic device, and an information transmission control and one or a plurality of interface elements are displayed on the game interaction interface, including: displaying the information transmission control at an initial position on the game interaction interface: displaying the information transmission control at a target position on the game interaction interface in response to a third touch operation on the information transmission control, where the initial position and the target position are respectively located in a left region and a right region of the game interaction interface.

In an example of the present disclosure, the third touch operation includes one or any combination of a single-click touch operation, a double-click touch operation, a multi-click touch operation, or a long-press touch operation.

In an example of the present disclosure, displaying the information transmission control at the target position on the game interaction interface includes: controlling the information transmission control to move from the initial position to the target position on the game interaction interface.

In an example of the present disclosure, after acquiring the prompt information corresponding to the interface element, the method further includes: performing display and voice broadcast of the prompt information on the game interaction interface.

In an example of the present disclosure, the displaying the information transmission control at the target position on the game interaction interface in response to the third touch operation on the information transmission control includes: in response to the third touch operation on the information transmission control, acquiring a movement state of a touch point corresponding to the third touch operation: in response to the movement state meeting a preset condition, if the time during which the touch point corresponding to the third touch operation stays on the interface element when the third touch operation ends at the interface element is less than a first preset time, displaying the information transmission control at the target position on the game interaction interface: where the preset condition includes: within a second preset time, a moving distance of the touch point corresponding to the third touch operation being greater than a preset distance, and a moving direction of the touch point corresponding to the third touch operation being within a preset direction range: or within the second preset time, a moving speed of the touch point corresponding to the third touch operation being greater than a preset speed, and the moving direction of the touch point corresponding to the third touch operation being within the preset direction range.

In an example of the present disclosure, when the initial position of the information transmission control is located in the left region of the game interaction interface and the target position is located in the right region of the game interaction interface, the preset direction range is a direction toward the right; and when the initial position of the information transmission control is located in the right region of the game interaction interface and the target position is located in the left region of the game interaction interface, the preset direction range is a direction toward the left.

In an example of the present disclosure, after displaying the information transmission control at the target position on the game interaction interface, the method further includes: in response to that a second touch operation on the information transmission control at the target position is not detected within a third preset time, cancelling displaying the information transmission control at the target position.

In an example of the present disclosure, after acquiring the prompt information corresponding to the interface element, the method further includes: canceling displaying the information transmission control at the target position.

In an example of the present disclosure, after detecting the second touch operation on the information transmission control, the method further includes: if the time during which the touch point corresponding to the second touch operation stays on the interface element is less than the first preset time, canceling displaying the information transmission control at the target position.

In an example of the present disclosure, the interface element at least includes one of a player virtual character, a control, a virtual object, and a non-player virtual character.

It should be noted that for the sake of simple description, the method embodiments are all expressed as a series of action combinations, but those skilled in the art should know that the disclosed embodiment is not limited by the described action sequence, because some steps may be performed in other sequences or simultaneously according to the embodiments of the present disclosure. Secondly, those skilled in the art should also know that all the embodiments described in the specification belong to the preferred embodiments, and the actions involved are not necessarily necessary for the embodiments of the present disclosure.

Referring to FIG. 9, a structural block diagram of an apparatus for transmitting information provided in an embodiment of the present disclosure is shown. A game interaction interface is displayed through an electronic device, and an information transmission control and an interface element are displayed on the game interaction interface, which may specifically include the following modules:
a first control display module 901, configured to display the information transmission control at an initial position on the game interaction interface;
a state acquisition module 902, configured to acquire a movement state of a touch point corresponding to the first touch operation in response to a first touch operation on the information transmission control;
a determining module 903, configured to determine a time during which the touch point corresponding to the first touch operation stays on an interface element when the touch point ends at the interface element in response to the movement state meeting a preset condition;
a second control display module 904, configured to display the information transmission control at a target position on the game interaction interface if the time is less than a first preset time, where the initial position and the target position are respectively located in a left region and a right region of the game interaction interface;
an information transmission module 905, configured to acquire prompt information corresponding to the interface element and transmit the prompt information to the teammate if the time is greater than or equal to the first preset time.

In an embodiment of the present disclosure, the apparatus for transmitting information further includes:
an information transmission module, further configured to acquire the prompt information corresponding to the interface element and transmit the prompt information to the teammate if the touch point corresponding to the first touch operation moves from the initial position to the interface element and the time during which the touch point corresponding to the first touch operation stays on the interface element is greater than or equal to the first preset time.

In an embodiment of the present disclosure, the second control display module 904 includes: a control moving submodule, configured to control the information transmission control to move from the initial position to the target position on the game interaction interface.

In an embodiment of the present disclosure, the apparatus for transmitting information further includes:
an information broadcasting module, configured to perform display and voice broadcast of the prompt information on the game interaction interface.

In an embodiment of the present disclosure, the preset condition includes: within a second preset time, a moving distance of the touch point corresponding to the first touch operation being greater than a preset distance, and a moving direction of the touch point corresponding to the first touch operation being within a preset direction range: or within the second preset time, a moving speed of the touch point corresponding to the first touch operation being greater than a preset speed, and the moving direction of the touch point corresponding to the first touch operation being within the preset direction range.

In an embodiment of the present disclosure, when the initial position of the information transmission control is located in the left region of the game interaction interface and the target position is located in the right region of the game interaction interface, the preset direction range is a direction toward the right.

When the initial position of the information transmission control is located in the right region of the game interaction interface and the target position is located in the left region of the game interaction interface, the preset direction range is a direction toward the left.

In an embodiment of the present disclosure, the apparatus for transmitting information further includes:
a control canceling-display module, configured to cancel displaying the information transmission control at the target position without detecting the second touch operation on the information transmission control within a second preset time.

In an embodiment of the present disclosure, the apparatus for transmitting information further includes:
a control canceling-display module, further configured to cancel displaying the information transmission control at the target position.

In an embodiment of the present disclosure, the apparatus for transmitting information further includes:
a control canceling-display module, further configured to cancel displaying the information transmission control at the target position if the time during which the touch point corresponding to the second touch operation stays on the interface element is less than the first preset time.

In an embodiment of the present disclosure, the interface element at least includes one of a player virtual character, a skill control, a virtual object, and a non-player virtual character.

As for the apparatus embodiment, because it is basically similar to the method embodiment, the description is relatively simple, and the relevant points may only be found in part of the description of the method embodiment.

Preferably: an embodiment of the present disclosure further provides an electronic device, which includes: a processor, a memory, and a computer program stored in the memory and capable of running on the processor, and when the computer program is executed by the processor, various processes of the embodiment of the method for transmitting information may be realized, and the same technical effect may be achieved. To avoid repetition, the processes will not be repeated here.

An embodiment of the present disclosure further provides a non-transitory computer-readable storage medium, and a computer program is stored on the non-transitory computer-readable storage medium. When the computer program is executed by the processor, various processes of the above-mentioned method for transmitting information embodiment may be realized, and the same technical effect may be achieved, so to avoid repetition, the processes are not repeated here. The computer-readable storage medium is, such as read-only memory (ROM), random access memory (RAM), magnetic disk or optical disk, etc.

An embodiment of the present disclosure provides a computer program product, which is stored in a storage medium and executed by at least one processor to realize various processes of the above-mentioned embodiment of the method for transmitting information, and may achieve the same technical effect, so as to avoid repetition, the processes are not repeated here.

It should be noted that in this paper, the terms “comprising”. “including” or any other variation thereof are intended to encompass non-exclusive inclusion such that a process, method, article or apparatus that includes a list of elements includes not only those elements, but also other elements that are not explicitly listed, or also includes elements inherent to such a process, method, article or apparatus. Without further limitation, an element defined by the phrase “includes a . . . ” does not preclude the presence of additional identical elements in the process, method, article or terminal device including said element.

Through the description of the above embodiments, those skilled in the art may clearly understand that the methods of the above embodiments may be realized by means of software and necessary general hardware platform, and of course they may also be realized by hardware, but in many cases, the former is the better embodiment. Based on this understanding, the technical solution of the present disclosure, in essence or as a contribution to the prior art, may be embodied in the form of a software product that is stored in a storage medium (e.g., a ROM/RAM, a diskette, a CD-ROM) and that includes a number of instructions to cause a terminal (which may be a mobile phone, a computer, a server, an air conditioner, or a network device, etc.) to perform the methods described in various embodiments of the present disclosure.

The embodiments of the present disclosure have been described above with reference to the accompanying drawings, but the present disclosure is not limited to the above specific embodiments, which are only schematic, not restrictive. Under the inspiration of the present disclosure, ordinary technicians skilled in the art may make many forms without departing from the purpose of the present disclosure and the scope protected by the claims, which are all within the protection of the present disclosure.

Those skilled in the art may realize that the units and algorithm steps of various examples described in connection with the embodiments disclosed in the present disclosure may be implemented in electronic hardware, or a combination of computer software and electronic hardware. Whether these functions are implemented in hardware or software depends on the specific application and design constraints of the technical scheme. Skilled people may use different methods to implement the described functions for each specific application, but such implementation should not be considered beyond the scope of the present disclosure.

It may be clearly understood by those skilled in the art that for the convenience and conciseness of description, the specific working processes of the system, apparatus and unit described above may refer to the corresponding processes in the aforementioned method embodiments, and will not be repeated here.

In the embodiments provided by the present disclosure, it should be understood that the disclosed apparatus and method may be realized in other ways. For example, the apparatus embodiment described above is only schematic. For example, the division of the units is only a logical function division. In actual implementation, there may be other division methods, such as multiple units or components may be combined or integrated into another system, or some features may be ignored or not implemented. On the other hand, the mutual coupling or direct coupling or communication connection shown or discussed may be indirect coupling or communication connection through some interfaces, apparatus or units, which may be electrical, mechanical or other forms.

The units described as separate components may or may not be physically separated, and the components displayed as units may or may not be physical units, that is, they may be located in one place or distributed to multiple network units. Some or all of the units may be selected according to actual needs to achieve the purpose of the technical solution of this embodiment.

In addition, each functional unit in each embodiment of the present disclosure may be integrated into one processing unit, or each unit may exist physically alone, or two or more units may be integrated into one unit.

The functions may be stored in a computer-readable storage medium if they are realized in the form of software functional units and sold or used as independent products. Based on this understanding, the technical solution of the present disclosure may be embodied in the form of a software product, which is stored in a storage medium and includes several instructions to make a computer device (which may be a personal computer, a server, a network device, etc.) execute all or part of the steps of the method described in various embodiments of the present disclosure. The aforementioned storage medium include: a U disk, a mobile hard disk, a ROM, a RAM, a magnetic disk or an optical disk and other medium that may store program codes.

The above is only the specific implementation of the present disclosure, but the protection scope of the present disclosure is not limited to this. Any person familiar with the technical field may easily think of changes or substitutions within the technical scope disclosed in the present disclosure, which should be included in the protection scope of the present disclosure. Therefore, the scope of protection of the present disclosure should be based on the scope of protection of the claims.

1. A method for transmitting information, comprising:
displaying an information transmission control at an initial position on a game interaction interface; wherein the game interaction interface is displayed through an electronic device, and the information transmission control and an interface element are displayed on the game interaction interface;
in response to a first touch operation on the information transmission control, acquiring a movement state of a touch point corresponding to the first touch operation;
in response to the movement state meeting a preset condition, determining a time during which the touch point corresponding to the first touch operation stays on the interface element in a case that the touch point ends at the interface element;
in response to determining that the time is less than a first preset time, displaying the information transmission control at a target position on the game interaction interface, wherein the initial position is located in a left region of the game interaction interface and and the target position is located a right region of the game interaction interface; and
in response to determining that the time is greater than or equal to the first preset time, acquiring prompt information corresponding to the interface element and transmitting the prompt information to the teammate.

2. The method according to claim 1, further comprising:
in response to detecting that the touch point corresponding to the first touch operation ends at a non-interface element, displaying the information transmission control at the target position.

3. The method according to claim 1, wherein displaying the information transmission control at the target position on the game interaction interface comprises:
controlling the information transmission control to move from the initial position to the target position on the game interaction interface.

4. The method according to claim 1, further comprising:
performing display and voice broadcast of the prompt information on the game interaction interface.

5. The method according to claim 1, wherein the preset condition comprises at least one of:
within a second preset time, a moving distance of the touch point corresponding to the first touch operation being greater than a preset distance, and a moving direction of the touch point corresponding to the first touch operation being within a preset direction range; or
within a second preset time, a moving speed of the touch point corresponding to the first touch operation being greater than a preset speed, and a moving direction of the touch point corresponding to the first touch operation being within a preset direction range.

6. The method according to claim 5, wherein in response to that the initial position of the information transmission control is located in the left region of the game interaction interface and the target position is located in the right region of the game interaction interface, the preset direction range is a direction toward right; and
in response to that the initial position of the information transmission control is located in the right region of the game interaction interface and the target position is located in the left region of the game interaction interface, the preset direction range is a direction toward left.

7. The method according to claim 1, further comprising:
in response to determining that a second touch operation on the information transmission control at the target position is not detected within a third preset time, cancelling displaying the information transmission control at the target position.

8. The method according to claim 1, after acquiring the prompt information corresponding to the interface element, further comprising:
cancelling displaying the information transmission control at the target position.

9. The method according to claim 1, further comprising:
detecting a second touch operation on the information transmission control; and
in response to determining that the time during which a touch point corresponding to the second touch operation stays on the interface element is less than the first preset time, cancelling displaying the information transmission control at the target position.

10. The method according to claim 1, wherein the interface element comprises at least one of a player virtual character, a control, a virtual object or a non-player virtual character.

11. A method for transmitting information, comprising:
displaying an information transmission control at an initial position on a game interaction interface, wherein the game interaction interface is displayed through an electronic device, and the information transmission control and an interface element are displayed on the game interaction interface; and
in response to a third touch operation on the information transmission control, displaying the information transmission control at a target position on the game interaction interface, wherein the initial position is located in a left region of the game interaction interface and the target position is located a right region of the game interaction interface.

12. The method according to claim 11, wherein the third touch operation comprises one or any combination of a single-click touch operation, a double-click touch operation, a multi-click touch operation, or a long-press touch operation.

13. The method according to claim 11, wherein displaying the information transmission control at the target position on the game interaction interface comprises:
controlling the information transmission control to move from the initial position to the target position on the game interaction interface.

14. The method according to claim 11, further comprising:
in response to a second touch operation on the information transmission control, controlling the information transmission control to move from the target position to a position where the interface element is located, acquiring prompt information corresponding to the interface element; and
performing display and voice broadcast of the prompt information on the game interaction interface.

15. The method according to claim 11, wherein displaying the information transmission control at the target position on the game interaction interface in response to the third touch operation on the information transmission control comprises:
in response to the third touch operation on the information transmission control, acquiring a movement state of a touch point corresponding to the third touch operation;
in response to the movement state meeting a preset condition, in a case that the touch point corresponding to the third touch operation ends at the interface element and stays on the interface element for less than a first preset time, displaying the information transmission control at the target position on the game interaction interface;
wherein the preset conditions comprise at least one of:
within a second preset time, a moving distance of the touch point corresponding to the third touch operation being greater than a preset distance, and a moving direction of the touch point corresponding to the third touch operation being within a preset direction range: or
within a second preset time, a moving speed of the touch point corresponding to the third touch operation being greater than a preset speed, and a moving direction of the touch point corresponding to the third touch operation being within a preset direction range.

16. The method according to claim 15, wherein in a case that the initial position of the information transmission control is located in the left region of the game interaction interface and the target position is located in the right region of the game interaction interface, the preset direction range is a direction toward right; and
in a case that the initial position of the information transmission control is located in the right region of the game interaction interface and the target position is located in the left region of the game interaction interface, the preset direction range is a direction toward left.

17. The method according to claim 11, further comprising:
in response to determining that a second touch operation on the information transmission control at the target position is not detected within a third preset time, cancelling displaying the information transmission control at the target position.

18-19. (canceled)

20. The method according to claim 11, wherein the interface element comprises at least one of a player virtual character, a control, a virtual object or a non-player virtual character.

21. (canceled)

22. An electronic device, comprising a processor, a communication interface, a memory and a communication bus, wherein the processor, the communication interface and the memory communicate with each other through the communication bus:
the memory is configured to store a computer program; and
when executing the program stored in the memory, the processor is configured to:
display an information transmission control at an initial position on a game interaction interface; wherein the game interaction interface is displayed through an electronic device, and the information transmission control and an interface element are displayed on the game interaction interface;
in response to a first touch operation on the information transmission control, acquire a movement state of a touch point corresponding to the first touch operation;
in response to the movement state meeting a preset condition, determine a time during which the touch point corresponding to the first touch operation stays on the interface element when the touch point ends at the interface element;
in response to determining that the time is less than a first preset time, display the information transmission control at a target position on the game interaction interface, wherein the initial position is located in a left region of the game interaction interface and and the target position is located a right region of the game interaction interface; and
in response to determining that the time is greater than or equal to the first preset time, acquire prompt information corresponding to the interface element and transmit the prompt information to a teammate.

23. (canceled)

24. The method according to claim 11, further comprising:
performing a second touch operation on the information transmission control; and
in response to a touch point corresponding to the second touch operation ends at the interface element, acquiring prompt information corresponding to the interface element.
